(19) United States
(12) Patent Application Publication
(10) Pub. No.: US 2024/0360350 A1
(43) Pub. Date: Oct. 31, 2024

(54) HEAT DISSIPATION MOLDING AGENT AND HEAT DISSIPATION FILM OF MANUFACTURED BY USING THE SAME

(71) Applicant: L2Y CO.,LTD., Hwaseong-si (KR)

(72) Inventors: Hak Gue YEO, Cheonan-si (KR); June HUH, Yongin-si (KR); Ye Il KIM, Hwaseong-si (KR)

(21) Appl. No.: 18/140,602

(22) Filed: Apr. 27, 2023

(30) Foreign Application Priority Data
Apr. 25, 2023 (KR) 10-2023-0054314

(51) Int. Cl. C09K 5/14; C08G 77/08; C08G 77/12; C08G 77/20; C08J 5/18; C08K 13/06; C08L 83/04

(52) U.S. Cl. CPC C09K 5/14; C08G 77/08; C08G 77/12; C08G 77/20; C08J 5/18; C08K 13/06; C08L 83/04; C08J 2383/04; C08K 2003/282; C08K 3/36; C08K 7/18; C08K 9/06; C08K 2201/001; C08K 2201/005; C08K 2201/011; C08K 2201/014; C08L 2205/025

(57) ABSTRACT

Provided are a heat dissipation molding agent having an excellent heat dissipation property and a heat dissipation film formed using the heat dissipation molding agent. In two different component-type heat dissipation molding agents, various forms of heat dissipation fillers are included in a silicone resin. The heat dissipation fillers are treated to be hydrophobic, and an anti-settling agent is introduced to the heat dissipation molding agent. Accordingly, the miscibility of the heat dissipation fillers is improved and excellent heat dissipation properties are acquired.

### BACKGROUND

### 1. Technical Field

Example embodiments of the present inventive concept relates to a heat dissipation molding agent with improved heat transfer performance and a heat dissipation film manufactured using the same, and more preferably, to a heat dissipation molding agent with an improved heat dissipation property and a heat dissipation film manufactured using the heat dissipation molding agent.

### 2. Related Art

A heat dissipation film is a material that is attached to a heat-generating device to transfer heat to the outside. For a heat dissipation action, it is necessary to use a material with an excellent heat transfer property, and a function of effectively dissipating heat and preventing heat accumulation is required.

Recently, various problems have appeared in LED lights, computers, smart phones, and battery packs due to heat generation. Particularly, heat generated from the battery pack is one factor that degrades the performance of a battery. Heat generated in a secondary battery causes thermal runaway. When thermal shock occurs, the internal temperature of the secondary battery increases and adversely affects the action of an electrolyte. In severe cases, the electrolyte vaporizes, increasing the internal pressure of the battery, and after certain stages, a venting phenomenon in which the battery surface opens or explodes occurs.

To prevent this, a heat dissipation material is introduced to the exterior or surface of the battery pack. The heat dissipation material is necessarily attached to the surface of the battery pack, and needs to have shape controllability. That is, despite various shapes of battery packs, the heat dissipation material needs to be attached tightly along the surface in the form of a film. Accordingly, a heat dissipation molding agent in which heat dissipation materials are dispersed in a polymer matrix is used.

A heat dissipation molding agent is coated on a substrate, and is attached to a battery pack in the form of a film through a curing process. As the heat dissipation molding agent, a thermally conductive resin is used, and as the thermally conductive resin, polyurethane is used.

In Korean Patent No. 10-1848895, a heat dissipation composite material which uses a porous polyurethane resin and includes a thermally conductive filler therein is disclosed. A film is manufactured by dispersing a thermally conductive filler in a urethane monomer, drying, and thermally compression.

However, even when the heat dissipation property of a conventional heat dissipation film is initially secured, various problems occur over time.

First, there are layer separation and caking phenomena. Even when a molding agent in which the heat dissipation filler is dispersed in a polymer matrix is processed into the form of a film and cured, due to the difference in specific gravity between the polymer matrix and the heat dissipation filler, the heat dissipation filler in the polymer matrix does not maintain a dispersed state, forming a layer. That is, due to the heat dissipation filler with reduced dispersibility, the heat dissipation property is degraded. In addition, the caking phenomenon is a phenomenon in which a cured film is hardened due to contact with air, causing a phenomenon in which a heat dissipation film peels off a substrate due to thermal expansion or a mechanical impact.

The second problem is caused by an excessive load. For example, when a heat dissipation film is applied to a vehicle battery, heat dissipation films are formed on multiple battery packs, each heat dissipation film has a high load, causing a decrease in fuel efficiency of a vehicle.

Among the above-described problems, the layer separation and caking phenomena impair the long-term stability of the heat dissipation films. Accordingly, the development of a heat dissipation molding agent that can solve the layer separation and cracking phenomena and a heat dissipation film to which the heat dissipation molding agent is applied is required.

### SUMMARY

Accordingly, example embodiments of the present invention are provided to substantially obviate one or more problems due to limitations and disadvantages of the related art.

Example embodiments of the present invention provide two-component heat dissipation molding agents, which are able to have an improved heat dissipation property.

Example embodiments of the present invention also provide a heat dissipation film using the heat dissipation molding agents provided by resolving the first technical problem.

In some example embodiments, a heat dissipation molding agent includes a first-component heat dissipation molding agent and a second-component heat dissipation molding agent, wherein the first-component heat dissipation molding agent has a first silicone resin, a first heat dissipation filler, a crosslinking agent and a first anti-settling agent, the second-component heat dissipation molding agent has a second silicone resin, a second heat dissipation filler, a catalyst, and a second anti-settling agent, and the heat dissipation molding agent is formed by mixing the first-component heat dissipation molding agent and the second-component heat dissipation molding agent.

In other example embodiments, a heat dissipation film includes a polymer matrix in which a silicone resin is cured by a crosslinking gent; and a heat dissipation filler dispersed in the polymer matrix, wherein the heat dissipation filler includes spherical alumina having a size of 3 to 7 μm, platy alumina having a size of 0.1 to 1 μm, first spherical AlN having a size of 50 to 60 μm, second spherical AlN having a size of 80 to 100 μm, and platy silica having a size of 0.1 to 0.5 μm.

### BRIEF DESCRIPTION OF DRAWINGS

Example embodiments of the present invention will become more apparent by describing in detail example embodiments of the present invention with reference to the accompanying drawings, in which:

FIG. 1 is a schematic diagram illustrating the dissipation action of a heat dissipation film according to an example embodiment of the present invention.

### DESCRIPTION OF EXAMPLE EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numerals refer to like elements throughout the description of the figures.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments of the present invention will be described in further detail with reference to the accompanying drawings.

### EMBODIMENTS

A heat dissipation molding agent of the present invention has a silicone resin, a crosslinking agent, a catalyst, a heat dissipation filler, an anti-settling agent, and a retardant.

The silicone resin is a polymer matrix.

The silicone resin is a mixture of a first polydiorganosiloxane of Formula 1 below, a second polydiorganosiloxane of Formula 2 below, a first polydihydrogen siloxane of Formula 3 below, and a second polydihydrogen siloxane of Formula 4 below.

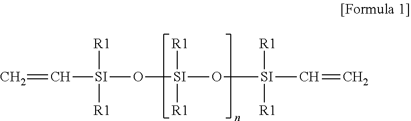

In Formula 1, R1 preferably includes C1 to C5 substituted or unsubstituted hydrocarbons, which do not contain an aliphatic unsaturated bond, and is, for example, a lower alkyl group (a methyl, ethyl, propyl or butyl group), an aryl group (a phenyl, xylene, or benzyl group), a cycloalkyl group such as a cyclohexyl group, or a chloromethyl, cyanomethyl, or 3,3,3-trifluoropropyl group, in which all or some of hydrogen atoms of this group are substituted with halogen or cyano groups, and n is 0 or a positive integer.

The first polydiorganosiloxane of Formula 1 is dimethylsiloxane, dimethylsiloxane methyl phenylsiloxane, or a copolymer thereof, in which both ends of the molecular chain are blocked with dimethylvinylsiloxane groups. The viscosity of the first polydiorganosiloxane is preferably 1,000 to 100,000 cp at room temperature.

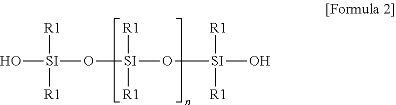

In Formula 2, R1 preferably includes C1 to C5 substituted or unsubstituted hydrocarbons, which do not include an aliphatic unsaturated bond, and is, for example, a lower alkyl group (a methyl, ethyl, propyl or butyl group), an aryl group (a phenyl, xylene, or benzyl group), a cycloalkyl group such as a cyclohexyl group, or a chloromethyl, cyanomethyl, or 3,3,3-trifluoropropyl group, in which all or some of hydrogen atoms of this group are substituted with halogen or cyano groups, and n is 0 or a positive integer.

The second polydiorganosiloxane of Formula 2 is one in which both ends of the molecular chain are blocked with dimethylvinylsiloxane groups and is dimethylsiloxane, a dimethylsiloxane-methyl phenylsiloxane copolymer, or a dimethylsiloxane-methyl trifluoropropyl siloxane copolymer, containing no unsaturated hydrocarbon group. The viscosity of the second polydiorganosiloxane is preferably 100 to 200,000 cp at room temperature.

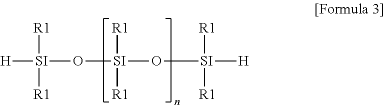

In Formula 3, R1 preferably includes C1 to C5 substituted or unsubstituted hydrocarbons, which do not contain an aliphatic unsaturated bond, and is, for example, a lower alkyl group (a methyl, ethyl, propyl or butyl group), an aryl group (a phenyl, xylene, or benzyl group), a cycloalkyl group such as a cyclohexyl group, or a chloromethyl, cyanomethyl, or 3,3,3-trifluoropropyl group, in which all or some of hydrogen atoms of this group are substituted with halogen or cyano groups, and n is 0 or a positive integer.

The polydihydrogen siloxane of Formula 3 is dimethylsiloxane, a dimethylsiloxane-methyl phenylsiloxane copolymer or a dimethylsiloxane-methyl trifluoropropyl siloxane copolymer, in which both ends of the molecular chain are blocked with dimethylvinylsiloxane groups, and does not contain an aliphatic unsaturated hydrocarbon group. The viscosity of the polydihydrogen siloxane is preferably 100 to 100,000 cp.

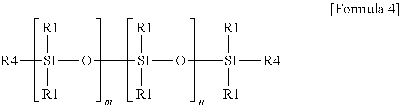

In Formula 4, R1 and R4 are preferably C1 to C5 unsubstituted or substituted hydrocarbons, containing no aliphatic unsaturated bond, and are, for example, a lower alkyl group (a methyl, ethyl, propyl or butyl group), an aryl group (a phenyl, xylene, or benzyl group), a cycloalkyl group such as a cyclohexyl group, or a chloromethyl, cyanomethyl, or 3,3,3-trifluoropropyl group, in which all or some of hydrogen atoms of this group are substituted with halogen or cyano groups, and n is 0 or a positive integer.

The second polydihydrogen siloxane of Formula 4 is a copolymer of dimethylsiloxane and methylhydrogen siloxane, in which both ends of the molecular chain are blocked with trimethylsiloxane groups, and has at least two hydrogen atoms bound to an Si atom in one molecule. The viscosity of the second polydihydrogen siloxane is preferably 100 to 20,000 cp at room temperature.

The silicone resin may further include a,w-hydrogen poly (dimethyl-methylphenyl) siloxane (HPDMS). HPDMS is used for adjusting the viscosity of a heat dissipation molding agent.

In the silicone resin, the first polydiorganosiloxane is contained at 15 to 25 wt %, the second polydiorganosiloxane is contained at 20 to 35 wt %, the first polydihydrogen siloxane is contained at 40 to 48 wt %, and the fourth polydihydrogen siloxane is contained at 0.1 to 1.5 wt %.

As a crosslinking agent, vinyltrimethoxy silane (CH₂═CHSi(OCH₃)₃) or phenyltrimethoxy silane (C₆H₅Si(OCH₃)₃) is used. The crosslinking agent connects silicone resins with each other to form a network, and modifies a heat dissipation filler to have a hydrophobic property through surface treatment. By the crosslinking agent, miscibility and dispersibility between the silicone resin and the heat dissipation filler are improved.

A catalyst includes Pt and is provided in the form of a hydrate. A usable catalyst is H₂PtCl₆·nH₂O, NaHPtCl₁₆·nH₂O, KHPtCl₆·nH₂O, Na₂PtCl₆·nH₂O, K₂PtCl₆·nH₂O, PtCl₄·nH₂O, PtCl₂, Na₂PtCl₄·nH₂O, or H₂PtCl₄·nH₂O. The catalyst induces a crosslinking reaction by the crosslinking agent in a curing process for forming the heat dissipation film.

The heat dissipation filler has a heat dissipation main material and a heat dissipation auxiliary material. The heat dissipation main material is spherical alumina, and the heat dissipation auxiliary material includes platy alumina and spherical AlN. As the heat dissipation auxiliary material, spherical BN and/or platy silica may be further included.

The spherical alumina has a size of 3 to 7 pm, and is included in the heat dissipation molding agent at 450 to 850 wt % relative to the silicone resin.

The platy alumina has a size of 0.1 to 1 pm and a content ratio of 10 to 45 wt % relative to the silicone resin. In addition, the spherical AlN has two sizes, the first spherical AlN has a size of 50 to 60 pm and is included at 80 to 300 wt % relative to the silicone resin, and the second spherical AlN has a size of 80 to 100 μm, which is larger than that of the first spherical AlN and is mixed in a weight ratio of 300 to 550 wt %. The platy silica has a size of 0.1 to 0.5 μm, and is included at 0.1 to 1 wt % relative to the silicone resin.

In the present invention, the spherical AlN has a relatively large size, and the platy alumina and the platy silica have small sizes. In addition, the heat dissipation main material, spherical alumina, has an intermediate size. Between the heat dissipation materials with relatively large sizes, the platy heat dissipation materials with very small sizes and the heat dissipation materials with intermediate sizes are disposed. Accordingly, a smooth heat dissipation action may be performed.

In addition, the heat dissipation filler affects the viscosity and thixotropy index (TI) value of the heat dissipation molding agent. When the size of the heat dissipation filler is small, the viscosity and the TI value increase, and when the size of the heat dissipation filler relatively increases, the viscosity and the TI value decrease. Therefore, to obtain a suitable viscosity and TI value for the heat dissipation film, the weight ratio of each of the heat dissipation fillers may be adjusted by those of ordinary skill in the art. This is associated with the overall surface area of the heat dissipation filler. As the overall surface area of the heat dissipation filler increases, the viscosity and the TI value increase.

In the present invention, a surface reaction between the crosslinking agent and the heat dissipation filler is described by the following reaction scheme.

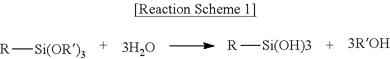

First, in the crosslinking agent R—Si(OR′)₃ (R: alkyl group), hydrolysis occurs, and the silanol group R—Si(OH)₃ is adhered to the surface of the heat dissipation filler. Through heating in the curing process, a siloxane bond is formed on the surface of the heat dissipation filler as shown in the following Reaction Scheme 2 and immobilized.

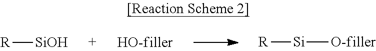

According to the above reaction scheme, the surface of the heat dissipation filler is treated to be hydrophobic.

The anti-settling agent prevents precipitation of the heat dissipation fillers with different loads in the polymer matrix, that is, the silicone resin, and allows uniform dispersibility in the heat dissipation molding agent by stirring.

As the anti-settling agent, polysiloxane is used. The anti-settling agent is included at 0.2 to 0.5 wt % relative to the silicone resin. When the anti-settling agent is contained in an amount less than the set range, a phenomenon in which some of the heat dissipation fillers are precipitated occurs, and when the anti-settling agent is contained in an amount more than the set range, the adhesion caused by the silicone resin is reduced, causing a phenomenon in which the formed heat dissipation film is peeled off of a substrate.

As the retardant, tetravinyl tetramethyl cyclo tetrasiloxane ([CH₃(CH₂═CH)SiO]₄) is used. The curing of the heat dissipation molding agent may be retarded by the retardant. When the curing proceeds rapidly, the roughness of the surface of the heat dissipation film may increase, and surface curing may proceed while curing in the heat dissipation film is incomplete, causing cracks inside the film. The retardant is included at 0.1 to 0.6 wt % relative to the silicone resin. When the retardant is contained in an amount less than the above-mentioned range, the curing delay is not smooth, resulting in increased surface roughness. In addition, when the content of the retardant exceeds the set range, process efficiency is reduced due to excessive curing time.

The heat dissipation molding agent having the above-described composition is formed in a two-component type. That is, a first syringe and a second syringe are prepared, the heat dissipation molding agent is separately injected into each syringe.

A first-component heat dissipation molding agent is introduced into the first syringe. The first-component heat dissipation molding agent has a silicone resin, a heat dissipation filler, a crosslinking agent, an anti-settling agent, and a retardant. A second-component heat dissipation molding agent is introduced into the second syringe. The second-component heat dissipation molding agent includes a silicone resin, a heat dissipation filler, a catalyst, and an anti-settling agent. The silicone resin, the heat dissipation filler and the anti-settling agent are commonly introduced into the two types of syringes. The anti-settling agent is necessarily added to ensure uniform dispersibility of the heat dissipation filler.

In addition, the first-component heat dissipation molding agent has a crosslinking agent and a retardant compared to the second-component heat dissipation molding agent. The retardant may be introduced into the second syringe, but is previously mixed with the crosslinking agent in the first syringe, resulting in effective delay of the crosslinking action of the crosslinking agent during curing. The crosslinking agent introduced into the first syringe makes the surfaces of the heat dissipation fillers hydrophobic, and prevents the layer separation phenomenon of the heat dissipation fillers in the subsequent mixing and coating processes of the two-types of heat dissipation molding agents.

In addition, a catalyst is introduced into the second syringe. As the crosslinking agent and the catalyst are introduced into different syringes, a curing action does not occur in the syringes.

Afterward, a coating process is performed on the substrate while mixing the two types of heat dissipation molding agents to form a heat dissipation film. After the coating process, a curing action is performed.

In the present invention, curing uses heat or light. Thermal curing is performed at 80 to 200° C. for 5 to 20 minutes. In addition, hybrid-type curing in which thermal curing and photocuring are mixed may be performed. For example, the curing may be performed by irradiating infrared rays at 80 to 200° C.

### Mixing Example 1: Preparation of Silicone Resin

A silicone resin is prepared by mixing 20 wt % first polydiorganosiloxane, 30 wt % second polydiorganosiloxane, 45.5 wt % first polydihydrogen siloxane, and 0.5 wt % second polydihydrogen siloxane.

### Preparation Example 1: Preparation of First-Component Heat Dissipation Molding Agent and Second-Component Heat Dissipation Molding Agent 1

The silicone resin of Mixing Example is put into a first container, and 5 μm-sized spherical alumina, 0.5 μm-sized platy alumina, 55 μm-sized first AlN, and 80 μm-sized second AlN are used.

The spherical alumina is mixed at 500 wt %, the platy alumina at 10 wt %, the first AlN at 102.3 wt %, and the second AlN at 300 wt % relative to the silicone resin.

A crosslinking agent vinyltrimethoxysilane is mixed at 1.58 wt %, an anti-settling agent polysiloxane at 0.348 wt %, and a retardant tetravinyl tetramethyl cyclotetrasiloxane at 0.4 wt % relative to the silicone resin.

The mixed solution in the first container is prepared into a first-component heat dissipation molding agent by stirring with an appropriate means. The first-component heat dissipation molding agent is introduced into a first syringe.

The silicone resin prepared according to Mixing Example is put into a second container, and 5 μm-sized spherical alumina, 0.5 μm-sized platy alumina, 55 μm-sized first AlN, and 80 μm-sized second AlN are used.

The spherical alumina is mixed at 500 wt %, the platy alumina at 10 wt %, the first AlN at 102.3 wt %, and the second AlN at 300 wt % relative to the silicone resin.

As a catalyst, H₂PtCl₆·nH₂O is mixed at 4.2 wt % relative to the silicone resin.

The mixed solution in the second container is prepared into a second-component heat dissipation molding agent by stirring with an appropriate means. The second-component heat dissipation molding agent is introduced into a second syringe.

### Preparation Example 2: Preparation of First-Component Heat Dissipation Molding Agent and Second-Component Heat Dissipation Molding Agent 2

The content ratio of the heat dissipation filler in the first-component and second-component heat dissipation molding agents in Preparation Example 1 is changed. The composition and contents are the same as those in Preparation Example 1, except that, in first-component and second-component heat dissipation molding agents, 450 wt % spherical alumina, 15 wt % platy alumina, 100 wt % first AlN, and 350 wt % second AlN relative to a silicone resin are mixed equally in syringes.

### Preparation Example 3: Preparation of First-Component Heat Dissipation Molding Agent and Second-Component Heat Dissipation Molding Agent 3

The content ratio of the heat dissipation filler in the first-component and second-component heat dissipation molding agents in Preparation Example 1 is changed. The composition and contents are the same as those in Preparation Example 1, except that, in first-component and second-component heat dissipation molding agents, 500 wt % spherical alumina, 10 wt % platy alumina, 102.3 wt % first AlN, and 500 wt % second AlN relative to a silicone resin are mixed equally in syringes.

### Preparation Example 4: Preparation of First-Component Heat Dissipation Molding Agent and Second-Component Heat Dissipation Molding Agent 4

The content ratio of the heat dissipation filler in the first-component and second-component heat dissipation molding agents in Preparation Example 1 is changed. The composition and contents are the same as those in Preparation Example 1, except that, in first-component and second-component heat dissipation molding agents, 450 wt % spherical alumina, 15 wt % platy alumina, 100 wt % first AlN, and 35 wt % second AlN relative to a silicone resin are mixed equally in syringes.

### Preparation Example 5: Preparation of First-Component Heat Dissipation Molding Agent and Second-Component Heat Dissipation Molding Agent 5

The content ratio of the heat dissipation filler in the first-component and second-component heat dissipation molding agents in Preparation Example 1 is changed. The composition and contents are the same as those in Preparation Example 1, except that, in first-component and second-component heat dissipation molding agents, 450 wt % spherical alumina, 10 wt % platy alumina, 90 wt % first AlN, and 400 wt % second AlN relative to a silicone resin are mixed equally in syringes.

### Preparation Example 6: Preparation of First-Component Heat Dissipation Molding Agent and Second-Component Heat Dissipation Molding Agent 6

The content ratio of the heat dissipation filler in the first-component and second-component heat dissipation molding agents in Preparation Example 1 is changed. The composition and contents are the same as those in Preparation Example 1, except that, in first-component and second-component heat dissipation molding agents, 500 wt % spherical alumina, 10 wt % platy alumina, 80 wt % first AlN, and 500 wt % second AlN relative to a silicone resin are mixed equally in syringes.

The first syringes and the second syringes in Preparation Examples 1 to 6 are separately stored and, subjected to mixing in a discharge nozzle, and the resulting mixed solution is coated on a substrate. After coating, the resultant substrate is cured at 250° C. for 10 minutes. After completing the curing process, the thermal conductivity of the prepared heat dissipation film is measured. The thermal conductivities of the heat dissipation films prepared using the heat dissipation molding agents of Preparation Examples 1 to 6 are shown in Table 1 below.

TABLE 1

| | Preparation | Preparation | Preparation | Preparation | Preparation | Preparation |
|---|---|---|---|---|---|---|
| Classification | Example 1 | Example 2 | Example 3 | Example 4 | Example 5 | Example 6 |
| Sample | 0.3687 | 0.3358 | 0.2892 | 0.2474 | 0.2075 | 0.4026 |
| thickness | | | | | | |
| [cm] | | | | | | |
| Thermal | 8.96 | 8.10 | 8.15 | 8.16 | 8.10 | 8.64 |
| conductivity | | | | | | |
| [W/(mK)] | | | | | | |

### Preparation Example 7: Preparation of First-Component Heat Dissipation Molding Agent and Second-Component Heat Dissipation Molding Agent 7

The content ratio of the heat dissipation filler in the first-component and second-component heat dissipation molding agents in Preparation Example 1 is changed. The composition and contents are the same as those in Preparation Example 1, except that, in first-component and second-component heat dissipation molding agents, 780 wt % spherical alumina, 20.4 wt % platy alumina, 100 wt % first AlN, and 430 wt % second AlN relative to a silicone resin are mixed equally in syringes.

### Preparation Example 8: Preparation of First-Component Heat Dissipation Molding Agent and Second-Component Heat Dissipation Molding Agent 8

The content ratio of the heat dissipation filler in the first-component and second-component heat dissipation molding agents in Preparation Example 1 is changed. The composition and contents are the same as those in Preparation Example 1, except that, in first-component and second-component heat dissipation molding agents, 800 wt % spherical alumina, 18 wt % platy alumina, 100 wt % first AlN, and 450 wt % second AlN relative to a silicone resin are mixed equally in syringes.

### Preparation Example 9: Preparation of First-Component Heat Dissipation Molding Agent and Second-Component Heat Dissipation Molding Agent 9

The content ratio of the heat dissipation filler in the first-component and second-component heat dissipation molding agents in Preparation Example 1 is changed. The composition and contents are the same as those in Preparation Example 1, except that, in first-component and second-component heat dissipation molding agents, 750 wt % spherical alumina, 20 wt % platy alumina, 200 wt % first AlN, and 500 wt % second AlN relative to a silicone resin are mixed equally in syringes.

### Preparation Example 10: Preparation of First-Component Heat Dissipation Molding Agent and Second-Component Heat Dissipation Molding Agent 10

The content ratio of the heat dissipation filler in the first-component and second-component heat dissipation molding agents in Preparation Example 1 is changed. The composition and contents are the same as those in Preparation Example 1, except that, in first-component and second-component heat dissipation molding agents, 780 wt % spherical alumina, 20.4 wt % platy alumina, 100 wt % first AlN, and 430 wt % second AlN relative to a silicone resin are mixed equally in syringes.

### Preparation Example 11: Preparation of First-Component Heat Dissipation Molding Agent and Second-Component Heat Dissipation Molding Agent 11

The content ratio of the heat dissipation filler in the first-component and second-component heat dissipation molding agents in Preparation Example 1 is changed. The composition and contents are the same as those in Preparation Example 1, except that, in first-component and second-component heat dissipation molding agents, 800 wt % spherical alumina, 30 wt % platy alumina, 220 wt % first AlN, and 510 wt % second AlN relative to a silicone resin are mixed equally in syringes.

### Preparation Example 12: Preparation of First-Component Heat Dissipation Molding Agent and Second-Component Heat Dissipation Molding Agent 12

The content ratio of the heat dissipation filler in the first-component and second-component heat dissipation molding agents in Preparation Example 1 is changed. The composition and contents are the same as those in Preparation Example 1, except that, in first-component and second-component heat dissipation molding agents, 810 wt % spherical alumina, 45 wt % platy alumina, 300 wt % first AlN, and 480 wt % second AlN relative to a silicone resin are mixed equally in syringes.

The first syringes and the second syringes in Preparation Examples 7 to 12 are separately stored and subjected to mixing in a discharge nozzle, and the resulting mixed solution was coated on a substrate. After coating, the resultant substrate is cured at 250° C. for 10 minutes. After completing the curing process, the thermal conductivity of the prepared heat dissipation film is measured. Table 2 below shows the thermal conductivities of the heat dissipation films prepared according to Preparation Examples, respectively.

TABLE 2

| | Preparation | Preparation | Preparation | Preparation | Preparation | Preparation |
|---|---|---|---|---|---|---|
| Classification | Example 7 | Example 8 | Example 9 | Example 10 | Example 11 | Example 12 |
| Sample | 0.3687 | 0.3358 | 0.2892 | 0.2474 | 0.2075 | 0.4026 |
| thickness | | | | | | |
| [cm] | | | | | | |
| Thermal | 10.23 | 10.10 | 10.12 | 10.43 | 10.10 | 10.42 |
| conductivity | | | | | | |
| [W/(mK)] | | | | | | |

Comparing Tables 1 and 2, the heat dissipation films of Preparation Examples 7 to 12 exhibit a high thermal conductivity of 10 W/(mK) or more. The data in Table 2 shows an increase in weight ratio of spherical alumina and also an increase in weight ratio of platy alumina compared to the data in Table 1.

In Preparation Examples, the spherical alumina has a size of 5 μm, and the platy alumina has a size of 0.5 μm. As the content ratio of the spherical alumina with a relatively large size increases, it is confirmed that a slight increase in the platy alumina with the smallest size is a key factor in improving thermal conductivity.

That is, the spherical alumina is preferably contained at 750 to 830 wt % and the platy alumina at 18 to 45 wt % relative to the silicone resin.

In addition, it can be seen that even when the content ratio of the second AlN with the largest size is changed, it does not have a significant effect on thermal conductivity. Even when the content ratio of the second AlN with the largest particle size in a heat transfer system is changed to 400 to 510 wt %, it does not have a significant effect on thermal conductivity.

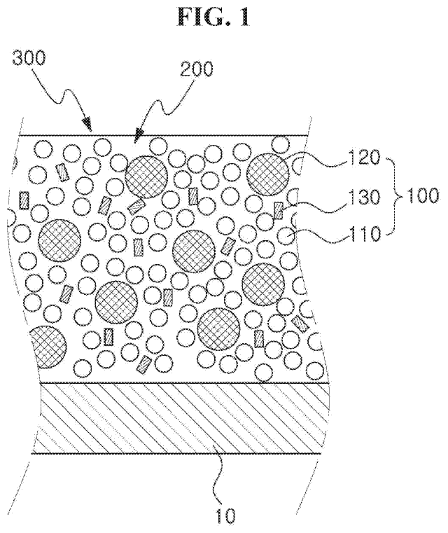

FIG. 1 is a schematic diagram illustrating the dissipation action of a heat dissipation film according to an example embodiment of the present invention.

Referring to FIG. 1, a heat dissipation film 300 is formed on a substrate 10. In the heat dissipation film 300, fillers 100 are disposed in a silicone polymer matrix 200 crosslinked by a curing process.

The silicone resin-based polymer matrix 200 has strong adhesive strength with the substrate 10 by the actions of a crosslinking agent and a catalyst. The crosslinking agent induces crosslinking between the silicone resins and performs hydrophobic treatment of the heat dissipation fillers 100. As the heat dissipation fillers 100 are treated to be hydrophobic, the effect of moisture penetrating into the polymer matrix 200 is minimized. In addition, the long-term stability of the heat dissipation film 300 is ensured by blocking external moisture.

Particularly, the specific gravity of the polymer matrix 200 is approximately 1.0, and the specific gravity of the alumina is approximately 4.0. In addition, the specific gravity of AlN is 2.8 to 2.9. In the present invention, an anti-settling agent is added to the heat dissipation molding agent. The layer separation phenomenon caused by the difference in specific gravity for each type of heat dissipation filler 100 is prevented by the anti-settling agent. Accordingly, the heat dissipation fillers 100 with different sizes and specific gravities are disposed in an even dispersed form.

In addition, compared to the polymer matrix 200, the content of alumina with a higher specific gravity is relatively reduced, and the content of AlN with a relatively lower specific gravity is significantly increased. Accordingly, the layer separation phenomenon may be prevented even when a small amount of the anti-settling agent is input.

In addition, looking at the thermal conductivity of each type of material, alumina has a conductivity of 25 W/(mK) and AlN has a conductivity of 270 W/(mK).

AlN having a high thermal conductivity has the largest size, and alumina having a relatively low thermal conductivity has a smaller size. Heat transfer is performed centered on AlN, spherical AlN 120 is disposed between particles of spherical alumina 110, and a considerable part of the surface of the spherical AlN 120 is in contact with the spherical alumina 110 to perform a heat dissipation action. In addition, between particles of the spherical alumina 110 or between the spherical alumina 110 and the spherical AlN 120, a small amount of platy alumina 130 is disposed. The heat transfer action by the platy alumina 130 is added, and the platy alumina 130 may increase the viscosity of the heat dissipation molding agent and thus can be used to adjust viscosity.

In the present invention, two heat dissipation molding agents with different component types are prepared, and the two different types of heat dissipation molding agents are stored in separate syringes. In a process of forming a heat dissipation film, the two types of heat dissipation molding agents introduced into different syringes are integrated in a nozzle and then discharged to form a heat dissipation film.

Since a retardant and a crosslinking agent are added to a first-component heat dissipation molding agent, the first-component heat dissipation molding agent has a lower viscosity than a second-component heat dissipation molding agent. The first-component heat dissipation molding agent preferably has a viscosity of 320,000 to 370,000 cp, and the second-component heat dissipation molding agent preferably has a viscosity of 450,000 to 530,000 cp. In addition, among these two types of heat dissipation molding agents, the second-component heat dissipation molding agent has a higher viscosity, and a difference in viscosity between the two molding agents is preferably 200,000 cp or less. When the difference in viscosity exceeds 200,000 cp, there is no problem in miscibility between the heat dissipation fillers, but the retardant and the crosslinking agent in the first-component heat dissipation molding agent are not evenly dispersed in the mixed heat dissipation molding agent, leading to a local rapid curing phenomenon. Accordingly, as some areas rapidly harden, polymer matrix bubbles are generated inside the polymer matrix, and the mechanical properties of the polymer matrix are degraded due to excessive contraction.

According to the present invention described as above, heat dissipation fillers having various sizes and types are introduced. In addition, the surface of each heat dissipation filler is treated to be hydrophobic using a crosslinking agent, and the heat dissipation fillers are uniformly dispersed in a heat dissipation molding agent. In addition, to prevent a layer separation phenomenon caused by the heat dissipation fillers with different specific gravities, an anti-settling agent is introduced, and the heat dissipation fillers are uniformly dispersed due to the anti-settling agent. Therefore, high thermal conductivity is secured.

In addition, through the adjustment of viscosity between two different component-type heat dissipation molding agents and a retardant, a caking phenomenon of the heat dissipation film can be prevented. The viscosity of a molding agent affects the thickness, surface flatness, and shape control of a heat dissipation film in a coating process. When the viscosity of a molding agent is low, the thickness of a heat dissipation film decreases and its surface flatness increases, but there is a difficulty in shape control. When a retardant is introduced in a curing process, a rapid curing phenomenon which may occur in a local area, is prevented, and a phenomenon in which a part of the surface is excessively cured is prevented. In other words, the caking phenomenon in which a part of the surface of a heat dissipation film hardens and the heat dissipation film is destroyed or peels off due to mechanical impact can be prevented.

While the example embodiments of the present invention and their advantages have been described in detail, it should be understood that various changes, substitutions and alterations may be made herein without departing from the scope of the invention.

### DESCRIPTION OF REFERENCE NUMERALS

| | |
|---|---|
| 10: Substrate | 100: Heat dissipation filler |
| 200: Polymer matrix | 300: Heat dissipation film |

What is claimed is:

1. A heat dissipation molding agent, comprising:
a first-component heat dissipation molding agent and a second-component heat dissipation molding agent,
wherein the first-component heat dissipation molding agent comprises a first silicone resin, a first heat dissipation filler, a crosslinking agent and a first anti-settling agent,
the second-component heat dissipation molding agent comprises a second silicone resin, a second heat dissipation filler, a catalyst, and a second anti-settling agent, and
the heat dissipation molding agent is formed by mixing the first-component heat dissipation molding agent and the second-component heat dissipation molding agent.

2. The heat dissipation molding agent of claim 1, wherein the first heat dissipation filler comprises spherical alumina having a size of 3 to 7 μm, platy alumina having a size of 0.1 to 1 μm, first spherical AlN having a size of 50 to 60 μm, second spherical AlN having a size of 80 to 100 μm, and platy silica having a size of 0.1 to 0.5 μm.

3. The heat dissipation molding agent of claim 2, wherein the spherical alumina is comprised at 450 to 850 wt %, the platy alumina is comprised at 10 to 45 wt %, the first spherical AlN is comprised at 80 to 300 wt %, the second spherical AlN is comprised at 300 to 550 wt %, the platy silica is comprised at 0.1 to 1 wt % relative to the first silicone resin.

4. The heat dissipation molding agent of claim 3, wherein the spherical alumina is comprised at 750 to 830 wt %, and the platy alumina is comprised at 18 to 45 wt % relative to the first silicone resin.

5. The heat dissipation molding agent of claim 1, wherein the anti-settling agent is polysiloxane.

6. The heat dissipation molding agent of claim 1, wherein the crosslinking agent comprises vinyltrimethoxysilane or phenyltrimethoxysilane.

7. The heat dissipation molding agent of claim 6, wherein the crosslinking agent forms a silanol group by hydrolysis on the surface of the heat dissipation filler to be adsorbed to the surface of the heat dissipation filler.

8. The heat dissipation molding agent of claim 7, wherein the silanol group forms a siloxane bond on the surface of the heat dissipation filler by a subsequent curing process.

9. The heat dissipation molding agent of claim 1, wherein the second-component heat dissipation molding agent has a higher viscosity than the first-component heat dissipation molding agent, and the difference in viscosity between the first-component heat dissipation molding agent and the second-component heat dissipation molding agent is 200,000 cp or less.

10. The heat dissipation molding agent of claim 1, wherein the first-component heat dissipation molding agent further comprises a retardant for delaying a curing action, and the retardant is tetravinyl tetramethyl cyclotetrasiloxane.

11. A heat dissipation film, comprising:
a polymer matrix in which a silicone resin is cured by a crosslinking agent; and
a heat dissipation filler dispersed in the polymer matrix,
wherein the heat dissipation filler comprises spherical alumina having a size of 3 to 7 μm, platy alumina having a size of 0.1 to 1 μm, first spherical AlN having a size of 50 to 60 μm, second spherical AlN having a size of 80 to 100 μm, and platy silica having a size of 0.1 to 0.5 μm.

12. The heat dissipation film of claim 11, wherein the spherical alumina is comprised at 450 to 850 wt %, the platy alumina is comprised at 10 to 45 wt %, the first spherical AlN is comprised at 80 to 300 wt %, the second spherical AlN is comprised at 300 to 550 wt %, and the platy silica is comprised at 0.1 to 1 wt %, relative to the first silicone resin.

13. The heat dissipation film of claim 12, wherein the spherical alumina is comprised at 750 to 830 wt %, and the platy alumina is comprised at 18 to 45 wt % relative to the first silicone resin.

14. The heat dissipation film of claim 13, which has a thermal conductivity of 10.1 to 10.43 W/(mK).

15. The heat dissipation film of claim 11, wherein the crosslinking agent comprises vinyltrimethoxysilane or phenyltrimethoxysilane.

16. The heat dissipation film of claim 15, wherein the crosslinking agent forms a silanol group by hydrolysis on the surface of the heat dissipation filler to be adsorbed to the surface of the heat dissipation filler, and the silanol group forms a siloxane bond on the surface of the heat dissipation filler by a subsequent curing process.
